(19) United States
(12) Patent Application Publication
(10) Pub. No.: US 2007/0124255 A1
(43) Pub. Date: May 31, 2007

(54) Pluggable heterogeneous reconciliation

(75) Inventors: Robert A. DiFalco, Portland, OR (US); Kenneth L. Keeler, Lake Oswego, OR (US); Robert L. Warmack, West Linn, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: Tripwire, Inc.

(21) Appl. No.: 11/289,207

(22) Filed: Nov. 28, 2005

(51) Int. Cl. G06Q 99/00; H04K 1/00; H04L 9/00

(52) U.S. Cl. 705/80; 705/1

(57) ABSTRACT

An automated method for facilitating management of a data processing environment, including pluggable heterogeneous reconciliation, is disclosed. In various embodiments, the method may include facilitating detecting of a change to an element of a data processing device of the data processing environment. In various embodiments, the method may further include facilitating determining a predicated reconciliation action, among a plurality of heterogeneous predicated reconciliation actions provided by a number of different vendors, to respond to a detected change. In various embodiments, the method may further include facilitating performing the determined reconciliation action. Other embodiments of the present invention may include, but are not limited to, apparatuses and systems adapted to facilitate practice of the above-described method.

### FIELD

Disclosed embodiments of the present invention relate generally to the field of data processing, and more particularly to pluggable heterogeneous reconciliation in data processing environments.

### BACKGROUND

Data processing devices are deployed in many different configurations and are used for many different applications in a variety of data processing environments. Management of a data processing environment may be performed in a number of nonexclusive ways. Changes may occur to data processing devices of a data processing environment. Compliance with various regulatory and/or other guidelines may be impacted by these changes.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1 illustrates some aspects of pluggable heterogeneous reconciliation, in accordance with various embodiments of this invention;

FIG. 2 illustrates some aspects of reconciliation, in accordance with various embodiments of this invention;

FIG. 3 illustrates parts of a reconciliation workflow, in accordance with various embodiments of this invention; and

FIG. 4 illustrates an example computer system suitable for use in association with heterogeneous reconciliation, in accordance with various embodiments of this invention.

### DETAILED DESCRIPTION OF ILLUSTRATIVE EMBODIMENTS

Embodiments of the present invention include, but are not limited to, an automated method for facilitating management of a data processing environment, including pluggable heterogeneous reconciliations. In various embodiments, the method may include facilitating detecting of a change to an element of a data processing device of the data processing environment. In various embodiments, the method may further include facilitating determining a predicated reconciliation action, among a plurality of heterogeneous predicated reconciliation actions provided by a plurality of different vendors, to respond to a detected change. In various embodiments, the method may further include facilitating performing the determined reconciliation action. Other embodiments of the present invention may include, but are not limited to, apparatuses and systems adapted to facilitate practice of the above-described method. While portions of the following discussion may primarily be presented in the context of specific types of data processing devices, it is understood that the principles described herein apply to a broad range of data processing devices.

In the following description, various aspects of embodiments of the present invention will be described. However, it will be apparent to those skilled in the art that other embodiments may be practiced with only some or all of the described aspects. For purposes of explanation, specific numbers, materials and configurations are set forth in order to provide a thorough understanding of the embodiments. However, it will be apparent to one skilled in the art that other embodiments may be practiced without the specific details. In other instances, well-known features are omitted or simplified in order not to obscure the description.

Parts of the descriptions of various embodiments will be presented in terms of operations performed by a processor-based device, using terms such as data and the like, consistent with the manner commonly employed by those skilled in the art to convey the substance of their work to others skilled in the art. As well understood by those skilled in the art, the quantities may take the form of electrical, magnetic, or optical signals capable of being stored, transferred, combined, and otherwise manipulated through mechanical and electrical components of the processor-based device; and the term processor includes microprocessors, micro-controllers, digital signal processors, and the like, that are standalone, adjunct or embedded.

Various operations will be described as multiple discrete operations in turn, in a manner that is most helpful in understanding the embodiments, however, the order of description should not be construed as to imply that these operations are necessarily order dependent. In particular, these operations need not be performed in the order of presentation.

The phrase “in some embodiments” is used repeatedly. The phrase does not generally refer to the same group of embodiments, however, it may. The phrase “in various embodiments” is used repeatedly. The phrase does not generally refer to the same group of embodiments, however, it may. The terms “comprising,” “having” and “including” are synonymous, unless the context dictates otherwise.

Some embodiments of the present invention include a scalable architecture to facilitate pluggable heterogeneous reconciliation in data processing environments containing data processing devices. Such data processing devices may include, but are not limited to, networking devices, servers, desktop computers, laptop computers, tablet computers, personal digital assistants, cellular phones, set top boxes, media players, or other types of data processing devices. In some embodiments, a data processing environment may comprise a continuously or intermittently connected environment of data processing devices, including data processing devices communicating through the Internet. In some embodiments, a data processing environment may comprise a directly or indirectly connected environment of data processing devices, including data processing devices communicating through the Internet. In various embodiments, one or more modules may facilitate the operations described herein.

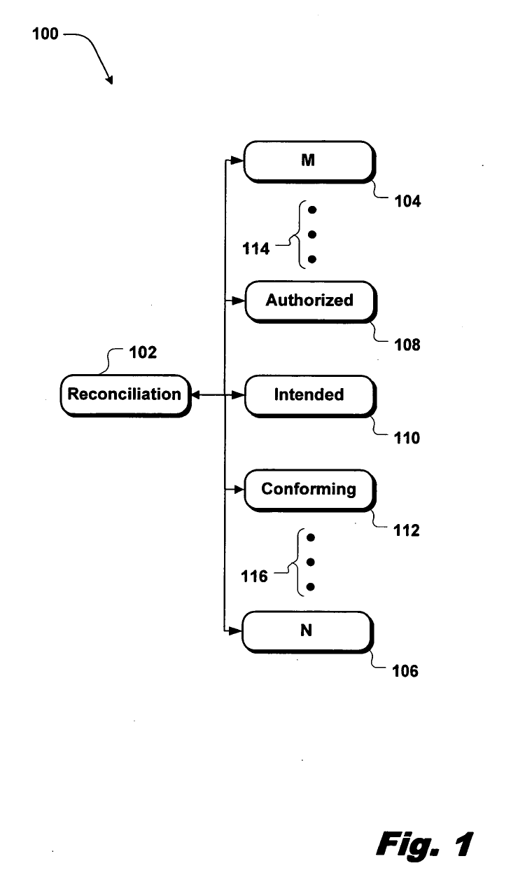

FIG. 1 illustrates some aspects of pluggable heterogeneous reconciliation 100, in accordance with various embodiments of this invention. Pluggable heterogeneous reconciliation 100 may include reconciliation operations 102. Reconciliation operations 102 may include multiple categories of potential operations, represented as operation category M 104 through operation category N 106, with graphics 114 and 116 representing any number of operation categories in-between. In various embodiments, the operation categories may be heterogeneous, i.e., different in nature. In various embodiments, operations within one operation category may be heterogeneous, i.e., different in nature. In various embodiments, category classification may not exist or may serve merely to conceptually organize reconciliation operations 102.

In various embodiments, the operation categories and/or operations within the operation categories may be provided by different providers (such as different vendors), and plugged (i.e., added) into installed reconciliation operations 102. In various embodiments, such multiple categories may include authorized operation category 108, intended operation category 110, and/or conforming operation category 112. In various embodiments, other categories of operations may additionally or alternatively exist. In various embodiments, potential operations may be classified in more than one category or may not be amenable to being classified in categories. In various embodiments, category classification may be independent of any reconciliation implementation. In other embodiments, category classification may at least be related to some aspects of reconciliation implementation.

An operation may comprise a predicated reconciliation action, a unary action, or another type of action. A predicated reconciliation action may comprise an action that performs a function based on a result of a determination of the predicated reconciliation action. In some embodiments, for example, a predicated reconciliation action may first make a determination, and then perform one of several functions based on the determination. As an example for illustration purposes, the determination may involve a query, with a first function being performed if an affirmative response is received, and a second function being performed if a negative response is received. In some embodiments, the determination may be more complex and/or involve multiple components. In some embodiments, more than two possible responses may result from a determination (for example, more than an affirmative response and a negative response). In some embodiments, a function may be associated with more than one possible response. In some embodiments, a function may be associated with each possible response. In some embodiments, a predicated reconciliation action may perform one function based on one or more possible results of a determination, and perform no functions otherwise. In some embodiments, a predicated reconciliation action may differ from the illustrative examples provided.

In contrast to a predicated reconciliation action, a unary action may perform a function directly without making a determination. In various embodiments, a predicated reconciliation action may, in response to its determination, invoke a unary action. In some embodiments, predicated reconciliation actions may not invoke unary actions.

In various embodiments, authorized operation category 108 may encompass an operation of determining whether a detected change was authorized. In various embodiments, authorized operation category 108 may encompass an operation of determining whether to allow a requested modification to be scheduled or assigned for implementation, in response to learning of a submission of the requested modification. In various embodiments, operations of authorized operation category 108 may operate in the context of determining whether a detected change is associated with a work ticket, a maintenance window, or the like. In various embodiments, operations of authorized operation category 108 may operate in the context of determining whether a detected change is “planned” or “unplanned.” In various embodiments, authorized operation category 108 may encompass operations of determining whether a detected change was authorized in other ways. In various embodiments, authorized operation category 108 may merely serve to conceptually organize one or more of the operations of reconciliation operations 102. In various embodiments, such conceptual organization may not be used.

In various embodiments, intended operation category 110 may comprise an operation of determining whether a detected change was intended. In various embodiments, an operation of intended operation category 110 may be performed in the context of reconciling a detected change with changes made by a change agent (not shown), or changes in-band, or known, to such a change agent. In various embodiments, such a change agent may include, but not be limited to, a configuration management tool. In various embodiments, an operation of intended operation category 110 may operate in the context of determining whether a detected change is “known” or “unknown.” In various embodiments, an operation of intended operation category 110 may comprise determining whether a detected change was intended in other ways. In various embodiments, intended operation category 110 may merely serve to conceptually organize one or more of the operations of reconciliation operations 102. In various embodiments, such conceptual organization may not be used.

In various embodiments, conforming operation category 112 may comprise an operation of determining whether a detected change was conforming. In various embodiments, conforming operation category 112 may include an operation of determining whether a detected change conforms with a conformance authority. In various embodiments, such a conformance authority may have one or more guidelines. In various embodiments, the conformance authority may include a policy-based management tool. In various embodiments, the conformance authority may include another type of tool, or may not include a tool. In various embodiments, operations of conforming operation 112 may operate in the context of determining whether a detected change is “desirable” or “undesirable.” In various embodiments, conforming operation category 112 may comprise an operation of determining whether a detected change conforms in other ways. In various embodiments, conforming operation category 112 may merely serve to conceptually organize one or more of the operations of reconciliation operations 102. In various embodiments, such conceptual organization may not be used.

In various embodiments, pluggable heterogeneous reconciliation may be performed to maintain or demonstrate control of an enterprise's information technology infrastructure. In various embodiments, pluggable heterogeneous reconciliation may be performed to maintain or demonstrate control of an enterprise's financial systems or data. In various embodiments, pluggable heterogeneous reconciliation may be performed to maintain or demonstrate control of an enterprise's business processes, such as, for example, enterprise resource planning (ERP) or customer relationship management (CRM). In various embodiments, pluggable heterogeneous reconciliation may be performed to facilitate compliance with governmental laws/regulations regarding establishment and maintenance of an internal control structure and/or procedures for financial reporting, such as, for example, the Sarbanes-Oxley Act (the Public Company Accounting Reform and Investor Protection Act), including any amendments and/or successor Acts to any part of the Sarbanes-Oxley Act, or the like.

In various embodiments, pluggable heterogeneous reconciliation may be performed to facilitate compliance with a number of laws, regulations, or guidelines, including but not limited to, the Gramm Leach Bliley Act, the regulations of Food and Drug Administration 21 Code of Federal Regulations 11, the Health Insurance Portability & Accountability Act, the Visa Cardholder Information Security Plan (CISP), the Payment Card Industry (PCI) Data Security Standard, the National Credit Union Administration Guidelines, the Office of the Comptroller of the Currency Guidelines, the International Organization for Standardization 17799, Common Criteria Certification, California Civil Code Senate Bill 1386 (California Security Breach Information Act), or the like, including any amendments and/or successors to any of the above, or the like.

In various embodiments, pluggable heterogeneous reconciliation may be performed as part of an audit of an enterprise, including but not limited to, a financial accounting or statement audit. In some such embodiments, pluggable heterogeneous reconciliation method may be performed to at least provide an audit trail for said audit.

In various embodiments where pluggable heterogeneous reconciliation is performed to maintain or demonstrate control of an enterprise's information technology infrastructure, financial systems or data, or business processes, use of pluggable heterogeneous reconciliation may occur in a number of areas, including but not limited to, access control, network security, auditing and monitoring of security-related events, or the like. In various embodiments where pluggable heterogeneous reconciliation is performed to maintain or demonstrate control of an enterprise's information technology infrastructure, financial systems or data, or business processes, said maintenance or demonstration of control may include other aspects of an enterprise's information technology infrastructure, financial systems or data, or business processes, respectively.

In various embodiments where pluggable heterogeneous reconciliation is performed as part of an audit of an enterprise, or to facilitate compliance with governmental laws/regulations, use of pluggable heterogeneous reconciliation may occur in a number of areas, including but not limited to, access control, network security, auditing and monitoring of security-related events, or the like. In various other embodiments, where pluggable heterogeneous reconciliation is performed as part of an audit of an enterprise, or to facilitate compliance with governmental laws/regulations, use of pluggable heterogeneous reconciliation may include other aspects of an enterprise audit or regulatory compliance procedures, respectively.

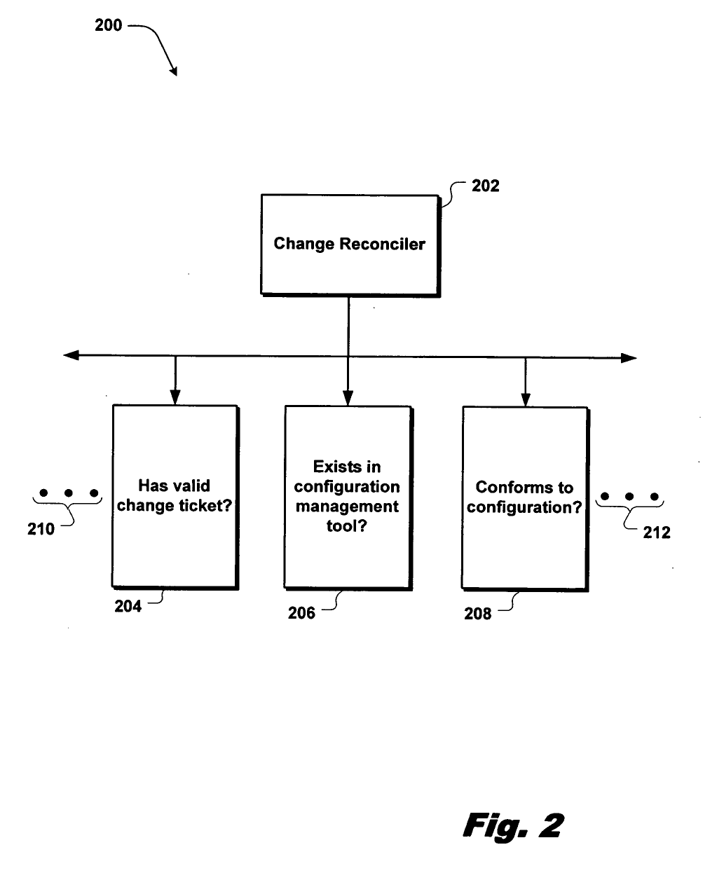

FIG. 2 illustrates some aspects of reconciliation 200, in accordance with various embodiments of this invention. Reconciliation 200 may represent an implementation of reconciliation operations 102 of FIG. 1, in accordance with various embodiments. In other embodiments, reconciliation operations 102 of FIG. 1 may be implemented in other manners. Reconciliation 200 may include Change Reconciler 202. Change Reconciler 202 may interface with predicated reconciliation actions, such as, for example, Has valid change ticket? 204, Exists in configuration management tool? 206, and Conforms to configuration? 208, with graphics 210 and 212 representing any number of other such predicated reconciliation actions. Predicated reconciliation actions 204, 206 and 208 are shown in FIG. 2 for illustrative purposes, as the number and type of predicated reconciliation actions will vary according to the desired actions to be implemented in any given embodiment. While predicated reconciliation actions are illustrated in FIG. 2, other possible actions may comprise unary actions in various embodiments, such as sending an email or a Simple Network Management Protocol (SNMP) trap. In various embodiments, predicated reconciliation actions may themselves invoke a unary action.

Predicated reconciliation actions may be added, or plugged in, to interface with Change Reconciler 202, as desired to provide for additional types of reconciliation operations. For example, in various embodiments where a change is detected by asserting a rule, a new type of predicated reconciliation action may be created and associated with the applicable rule. When changes are detected based upon the assertion of that rule, the predicated reconciliation action may resultantly be invoked. In various other embodiments, additional types of reconciliation operations may be added, or plugged in, in other ways.

In various embodiments, Change Reconciler 202 may facilitate performance of the predicated reconciliation actions. In some such embodiments, Change Reconciler 202 may comprise a root object. In some embodiments, a predicated reconciliation action may perform a callback registration to Change Reconciler 202. In some embodiments, Change Reconciler 202 may be informed of the presence of the predicated reconciliation action, what change the predicated reconciliation action acts on, where to call the predicated reconciliation action back, and the predicated reconciliation action's requested data. In some embodiments, Change Reconciler 202 may, at the appropriate time, perform a callback to the applicable predicated reconciliation action providing the requested data or where the requested data may be found. In various other embodiments, Change Reconciler 202 may operate in other manners.

In various embodiments, Has valid change ticket? 204 may determine whether a detected change can be reconciled with a change management service. Such a change management service may manage change requests for changes to hardware, software and/or data of various devices submitted from various sources, such as, for example, by various end users and/or information technology administrators of a data processing environment. Upon determining whether a detected change can be reconciled with a change management service, Has valid change ticket? 204 may baseline the change if reconciliation is possible, alert regarding the change if reconciliation is not possible, or perform other actions based on its determination. In various other embodiments, Has valid change ticket? 204 may be implemented in other ways.

In various embodiments, Exists in configuration management tool? 206 may determine whether a detected change can be reconciled with an installed packages database. Upon such a determination, Exists in configuration management tool? 206 may either baseline the change if reconciliation is possible, alert regarding the change if reconciliation is not possible, or perform other actions based on its determination. In various other embodiments, Exists in configuration management tool? 206 may be implemented in other ways.

In various embodiments, Conforms to configuration? 212 may determine whether a detected change conforms to a configuration for the applicable type of element. Upon such a determination, Conforms to configuration? 212 may baseline the change if reconciliation is possible, alert regarding the change if reconciliation is not possible, or perform other actions based on its determination. In various other embodiments, Conforms to configuration? 212 may be implemented in other ways.

For illustrative purposes, a more detailed example of Conforms to configuration? 212 may comprise using a router provided with some embodiments of the invention, having one or more elements associated with it, including but not limited to, a start-up configuration. The start-up configuration of the router may have content classifiable as subsets of the start-up configuration, such as, but not limited to, parameters. One such parameter may be a time to live (TTL) parameter. A change may occur to the TTL parameter in the start-up configuration, such as, for example, by a network administrator making the change. Such a change may subsequently be detected. In the instance of available configuration guidelines encompassing a TTL parameter, conformance of the change may be reconciled with the TTL range provided by such guidelines. If the changed TTL parameter is determined to be outside of the range provided by guidelines, then a number of operations may occur in various embodiments. A TTL parameter is used herein as just one example of a possible operational context of various embodiments. Another such exemplar may be guidelines being used in the context of a registry, where a change is detected in a setting of the registry, and reconciliation of the change with guidelines for the registry is facilitated. Many such operational contexts are possible, such as facilitating conformance of a security parameter on detection of a change with the security parameter, as would be readily apparent to one skilled in the art.

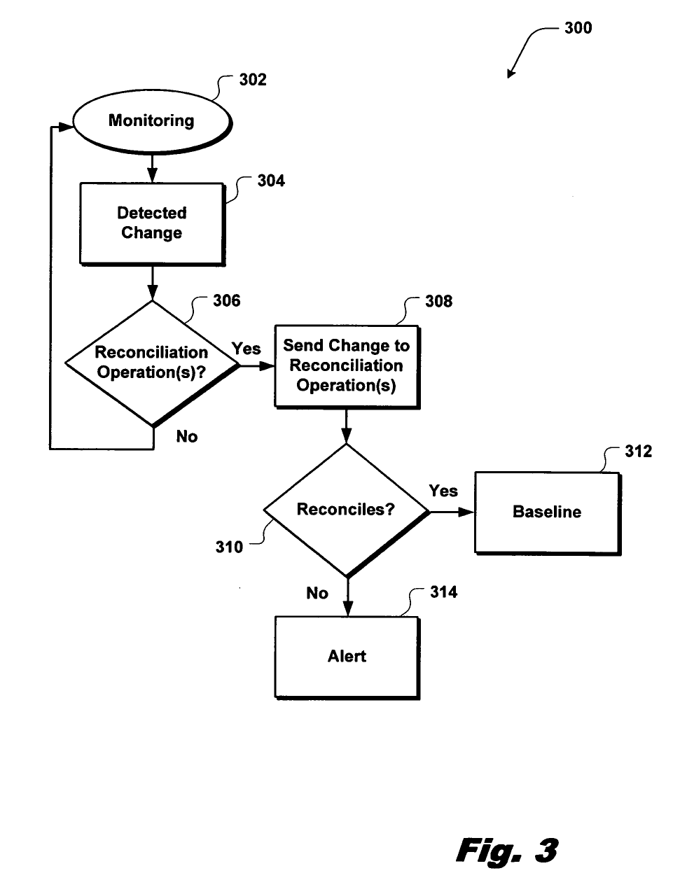

FIG. 3 illustrates parts of reconciliation workflow 300, in accordance with various embodiments of this invention. While certain blocks are illustrated in FIG. 3, other blocks may supplement or supplant the blocks shown, in the context of various embodiments. Reconciliation workflow 300 may include Monitoring 302, where the detecting of a change to an element of a data processing device of a data processing environment may be facilitated. Reconciliation workflow 300 may further include blocks Reconciliation Operation(s)? 306 and Send Change to Reconciliation Operation(s) 308 to facilitate determining a predicated reconciliation action, among a plurality of predicated reconciliation actions, to respond to Detected Change 304. In some embodiments, Change Reconciler 202 of FIG. 2 may serve to at least partially perform Reconciliation Operation(s)? 306 and Send Change to Reconciliation Operation(s) 308, while in other embodiments, Reconciliation Operation(s)? 306 and Send Change to Reconciliation Operation(s) 308 may be performed in other manners.

In various embodiments, upon a negative determination of Reconciliation Operation(s)? 306, Monitoring 302 may continue. In various embodiments, a negative determination of Reconciliation Operation(s)? 306 may result in another block (not shown). In various embodiments, facilitating determining the predicated reconciliation action may take other forms, and may include one block or multiple sub-blocks. In various embodiments, Reconciles? 310 may follow Send Change to Reconciliation Operation(s) 308.

Reconciles? 310, Baseline 312, and Alert 314 may represent high-level functionality of aspects of a predicated reconciliation action, in accordance with various embodiments of the invention. Such a predicated reconciliation action may perform block Reconciles? 310, resulting in Baseline 312 or Alert 314, in accordance with various embodiments of the invention. In other embodiments, a predicated reconciliation action may be represented in other manners.

In various embodiments, facilitating determining the predicated reconciliation action may comprise making use of associations of predicated reconciliation actions with potential changes. In various such embodiments, a plurality of predicated reconciliation actions may be associated with one of the potential changes. In some embodiments in which a plurality of predicated reconciliation actions are associated with one potential change, the plurality of predicated reconciliation actions may be members of an ordered set of predicated reconciliation actions.

In various embodiments, if Reconciles? 310 is determined in the affirmative, then Baseline 312, may follow in various embodiments. In various embodiments, Baseline 312 may include changing a baseline of an element of a data processing device to incorporate the change detected. In various embodiments, Baseline 312 may include additional or alternative sub-blocks. In various embodiments, a baseline of an element may include a full version of the element. In various embodiments, a baseline of an element may include a text version of the element. In one such embodiment in the case where the element is a file, the baseline of the file may include a text version of the file. In various other embodiments, a baseline of an element may additionally or alternatively include other things, including but not limited to, attributes of the element.

In various embodiments, one or more blocks other than Baseline 312 may follow an affirmative determination of Reconciles? 310. In various embodiments, Reconciles? 310 being determined in the affirmative may be followed by modifying a severity state of the detected change (not shown), such as decreasing it. In various embodiments, Reconciles? 310 being determined in the affirmative may be followed by automatic approval of the detected change(s) without modification to the baseline state. In some other embodiments, another response may follow an affirmative determination of Reconciles? 310.

If Reconciles? 310 is determined in the negative, then Alert 314 may follow in various embodiments. In various embodiments, Alert 314 may include alerting that a detected change was unauthorized. In various embodiments, Alert 314 may include alerting that a detected change was unintended. In various embodiments, Alert 314 may include alerting the nonconformance of a detected change. In various embodiments, Alert 314 may include an alert of another category of detected change. Alerting of a detected change may take many forms, according to various embodiments, including but not limited to, creating a helpdesk incident, alerting with a severity state indicator of the change in a graphical user interface (GUI), notifying a user (for example, a system administrator), reverting the element, or a portion of the element, back to its baseline state, etc.

In various embodiments, Reconciles? 310 being determined in the negative may be followed by modifying a severity state of the change detected, such as increasing it. In various embodiments, Alert 314 may include facilitating a user to modify the element at issue to be within authorized guidelines, intended guidelines, conforming guidelines, and/or other categories of guidelines. In some embodiments, such facilitation may include reporting the one or more guidelines that were violated by the detected change. In various embodiments, such facilitation may include other sub-operations.

In various other embodiments, Reconciles? 310 being determined in the negative may be followed by various other blocks. The sophistication of Reconciles? 310 may vary widely, depending on the implementation and the information available to make the reconciliation determination. In various embodiments, a further block of determining one or more users associated with the detected change may be included. In various embodiments, Alert 314 may include the one or more users associated with the detected change. In some embodiments, the one or more users associated with the detected change may be the user(s) determined to have caused the change.

In various embodiments, one or more user defined blocks may follow an affirmative determination of Reconciles? 310. In various embodiments, one or more user defined blocks may follow a negative determination of Reconciles? 310. In some such embodiments, in either the instance of an affirmative or a negative determination of Reconciles? 310, user definition may comprise the predicated reconciliation action being user configurable to select a function among a plurality of functions for a given determination result. In some such embodiments, in either the instance of an affirmative or a negative determination of Reconciles? 310, user definition may comprise the predicated reconciliation action being partially or completely user defined.

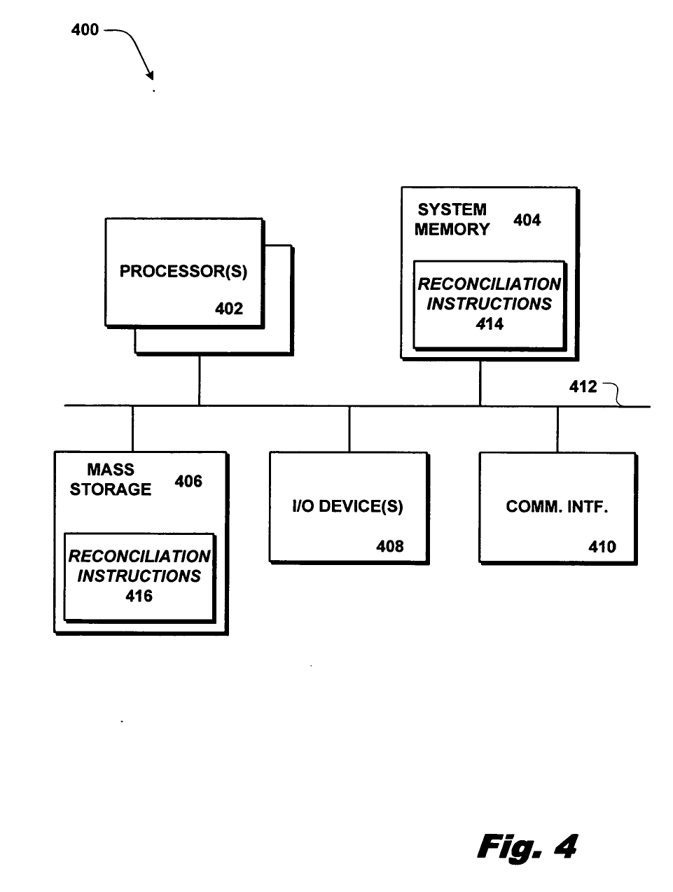

FIG. 4 illustrates an example computer system suitable for use in association with pluggable heterogeneous reconciliation, in accordance with various embodiments of this invention. As shown, computer system 400 may include one or more processors 402 and may include system memory 404. Additionally, computer system 400 may include mass storage 406 in the form of one or more devices (such as diskette, hard drive, compact disk (CD), flash memory, and so forth), input/output devices 408 (such as keyboard, cursor control and so forth) and communication interfaces 410 (such as network interface cards, modems and so forth). The elements may be coupled to each other via system bus 412, which may represent one or more buses. In the case where system bus 412 represents multiple buses, the multiple buses may be bridged by one or more bus bridges (not shown).

These elements each perform their conventional functions known in the art. In various embodiments, communication interfaces 410 may facilitate coupling of computing system 400 to a network, though which computing system 400 may be coupled to a data processing device and so forth. In various embodiments, computing system 400 may at least be partially incorporated in a data processing device. System memory 404 and mass storage 406 may be employed to store a working copy and a permanent copy of the programming instructions implementing various aspects of the one or more earlier described embodiments of the present invention. In various embodiments, Reconciliation Instructions 414 may comprise such a working copy, and Reconciliation Instructions 406 may comprise such a permanent copy. In various embodiments, nonvolatile memory may serve to hold one copy of any instructions, with the one copy serving the functions of both a working copy and a permanent copy of the instructions.

The permanent copy of the programming instructions may be loaded into mass storage 406 in the factory or in the field, through a distribution medium (not shown), or through communication interface 410 from, for example, a distribution server (not shown). The constitution of these elements 402-412 are known, and accordingly will not be further described. In alternate embodiments, part or all of the one or more modules may be implemented in hardware, for example, using one or more Application Specific Integrated Circuits (ASICs) instead.

Thus, it can be seen from the above description, an automated method for facilitating management of a data processing environment, in particular, reconciliations (including pluggable heterogeneous reconciliations) is described. In various embodiments, the method may include facilitating detecting of a change to an element of a data processing device of the data processing environment. In various embodiments, the method may further include facilitating determining a predicated reconciliation action, among a plurality of predicated reconciliation actions provided by a plurality of different vendors, to respond to a detected change. In various embodiments, the method may further include facilitating performing the determined reconciliation action. Other embodiments of the present invention may include, but are not limited to, apparatuses and systems adapted to facilitate practice of the above-described method. While the present invention has been described in terms of the foregoing embodiments, those skilled in the art will recognize that the invention is not limited to the embodiments described. Other embodiments may be practiced with modification and alteration within the spirit and scope of the appended claims. Accordingly, the description is to be regarded as illustrative instead of restrictive.

What is claimed is:

1. An automated method for facilitating management of a data processing environment comprising:
facilitating detecting of a change to an element of a data processing device of the data processing environment;
facilitating determining a predicated reconciliation action, among a plurality of heterogeneous predicated reconciliation actions provided by a plurality of different vendors for the data processing environment, to respond to a detected change; and
facilitating performing the determined reconciliation action.

2. The method of claim 1, wherein the facilitating determining comprises making use of associations of predicated reconciliation actions with potential changes.

3. The method of claim 2, wherein at least a plurality of the heterogeneous predicated reconciliation actions are associated with one of the potential changes.

4. The method of claim 3, wherein the plurality of heterogeneous predicated reconciliation actions associated with the one potential change are members of an ordered set of predicated reconciliation actions.

5. The method of claim 1, wherein the facilitating performing comprises using a change reconciler to interface with the determined reconciliation action.

6. The method of claim 1, wherein the predicated reconciliation action performs a function based upon a result of a determination of the predicated reconciliation action.

7. The method of claim 6, wherein the function is one selected from the group consisting of a baseline function and an alert function.

8. The method of claim 6, wherein the function is user defined.

9. The method of claim 6, wherein the predicated reconciliation action is user configurable to select the function among a plurality of functions.

10. The method of claim 1, wherein the plurality of heterogeneous predicated reconciliation actions comprises at least an authorized checking action and an intended checking action.

11. The method of claim 1, wherein the plurality of heterogeneous predicated reconciliation actions comprises at least an intended checking action and a conforming checking action.

12. The method of claim 1, wherein the plurality of heterogeneous predicated reconciliation actions comprises at least a conforming checking action and an authorized checking action.

13. The method of claim 1, wherein the data processing device is one selected from the group consisting of a networking device, a server, a desktop computer, a laptop computer, a tablet computer, a personal digital assistant, a cellular phone, a set top box, and a media player.

14. The method of claim 1, wherein the facilitating of detecting, determining and performing are performed to maintain or demonstrate control of an enterprise's information technology infrastructure.

15. The method of claim 1, wherein the facilitating of detecting, determining and performing are performed to maintain or demonstrate control of an enterprise's financial systems or data.

16. The method of claim 1, wherein the facilitating of detecting, determining and performing are performed to maintain or demonstrate control of an enterprise's business processes.

17. The method of claim 1, wherein the facilitating of detecting, determining and performing are performed as part of an audit of an enterprise.

18. The method of claim 17, wherein the facilitating of detecting, determining and performing are performed to provide an audit trail for said audit.

19. The method of claim 1, wherein the facilitating of detecting, determining and performing are performed to facilitate compliance with governmental laws/regulations regarding establishment and maintenance of an internal control structure and/or procedures for financial reporting.

20. An apparatus comprising:
a storage medium having stored therein instructions adapted to enable the apparatus to
facilitate detecting of a change to an element of a data processing device of a data processing environment,
facilitate determining a predicated reconciliation action, among a plurality of heterogeneous predicated reconciliation actions provided by a plurality of different vendors for the data processing environment, to respond to a detected change, and
facilitate performing the determined reconciliation action; and
one or more processors coupled to the storage medium and adapted to execute the instructions.

21. The apparatus of claim 20, wherein the instructions are configured to facilitating determining by making use of associations of predicated reconciliation actions with potential changes.

22. The apparatus of claim 21, wherein at least a plurality of the predicated reconciliation actions are associated with one of the potential changes, the plurality of predicated reconciliation actions being members of an ordered set of predicated reconciliation actions.

23. The apparatus of claim 20, wherein the instructions are configured to perform the facilitate performing by using a change reconciler to interface with the determined reconciliation action.

24. The apparatus of claim 20, wherein the instructions are configured to allow the predicated reconciliation action to perform a-function based upon a result of a determination of the predicated reconciliation action.

25. The apparatus of claim 24, wherein the instructions are configured to allow the function to be one selected from the group consisting of a baseline function and an alert function.

26. The apparatus of claim 24, wherein the instructions are configured to allow the predicated reconciliation action to be user configurable to select the function among a plurality of functions.

27. The apparatus of claim 20, wherein the instructions are configured to allow the predicated reconciliation action to be one selected from the group consisting of an authorized checking action, an intended checking action, and a conforming checking action.

28. The apparatus of claim 20, wherein the instructions are configured to allow at least a subset of the predicated reconciliation conditions to be associated with maintaining or demonstrating control of one or more selected from the group consisting of an enterprise's information technology infrastructure, an enterprise's financial systems, an enterprise's financial data, and an enterprise's business processes.
